(19) United States
(12) Patent Application Publication
(10) Pub. No.: US 2010/0323836 A1
(43) Pub. Date: Dec. 23, 2010

(54) CONCENTRICALLY ALIGNED PLANETARY GEAR ASSEMBLY AND POWER TRANSMISSION DEVICE

(75) Inventors: Hsin-Te Wang, Jhonghe City (TW); Guang-Miao Huang, Kaohsiung City (TW); Guo-Jhih Yan, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: METAL INDUSTRIES RESEARCH & DEVELOPMENT CENTRE, Kaohsiung (TW)

(21) Appl. No.: 12/638,455

(22) Filed: Dec. 15, 2009

(30) Foreign Application Priority Data
Jun. 23, 2009 (TW) 098120994

(51) Int. Cl. F16H 1/28; F16H 57/08; F16H 37/06; F16H 1/46

(52) U.S. Cl. 475/1; 475/331; 475/343; 475/332

(57) ABSTRACT

A concentrically aligned planetary gear assembly and a power transmission device are provided. The planetary gear assembly includes a ring gear, having a bottom cover and a top cover; a graded transmission module; a power input module, having a power shaft and a power input gear; and a power output module, having a planet wheel set and an output shaft. The graded transmission module includes a planetary arm and plural planetary gears. The planetary arm has a transmission tray and a coaxial sun gear, in which the transmission tray has plural planetary pivoting structures, and an outer diameter of the transmission tray is coaxial with an addendum circle of the internal gear, so as to be slidingly fitted to each other. The plurality of planetary gears is engaged with the internal gear, pivoted on the planetary pivoting structures, and freely rotates with respect to the planetary pivoting structures.

### CROSS-REFERENCE TO RELATED APPLICATION

This application claims the benefit of Taiwan Patent Application No. 098120994, filed on Jun. 23, 2009, which is hereby incorporated by reference for all purposes as if fully set forth herein.

### BACKGROUND OF THE INVENTION

1. Field of Invention

The present invention relates to a planetary gear assembly and a power transmission device, and more particularly to a concentrically aligned planetary gear assembly and a power transmission device.

2. Related Art

In the prior art, when assembling a planetary gear assembly, there is no desirable mechanism for finding out parts and components with poor processing precisions from all the parts, and after the planetary gear assembly is completely assembled, the parts and components with poor processing precisions easily cause interference, jam, or severe noises during the operation.

### SUMMARY OF THE INVENTION

Accordingly, the present invention is directed to a planetary gear assembly, which is suitable for excluding defective parts when parts of the planetary gear assembly are assembled together, and enabling a graded transmission module of the planetary gear assembly to easily form concentric alignment during operation.

To achieve the above objectives, a concentrically aligned planetary gear assembly is provided, which comprises a ring gear, having a bottom cover and a top cover disposed at two ends thereof, wherein an internal gear is formed in the ring gear; at least one graded transmission module, disposed inside the ring gear; a power input module, disposed at an inner side of the bottom cover, and having a power shaft and a power input gear secured at one end of the power shaft, wherein the power input gear is engaged with each of the planetary gears of a first stage graded transmission module, for inputting power to the graded transmission module; and a power output module, disposed at an inner side of the top cover, and having a planet wheel set and a secured output shaft, for outputting power of the sun gear of a last stage graded transmission module, wherein a hole is formed at a axle center of the planet wheel set. Moreover, the above graded transmission module comprises a planetary arm and a plurality of planetary gears. The planetary arm has a transmission tray and a sun gear integrated with the transmission tray, and the sun gear is concentric with the transmission tray. In addition, the transmission tray has a plurality of planetary pivoting structures distributed about an axle center of a bottom surface thereof at equal radiuses and equal angles, and a central concave hole is formed at an axle center on a bottom surface of the transmission tray. A central shaft is disposed at an axle center on a top surface of the sun gear, and an outer diameter of the transmission tray is coaxial with an addendum circle of the internal gear so as to be slidingly fitted to each other. The plurality of planetary gears is pivoted to the planetary pivoting structures on the bottom surface of the transmission tray and can freely rotates with respect to the planetary pivoting structures, wherein each of the planetary gears is engaged with the internal gear.

In the planetary pivoting structures, each of the planetary pivoting structures comprises a shaft hole on the transmission tray and a pin shaft fixed in the shaft hole, and each pin shaft is slidingly fitted with each of the planetary gears.

In the planetary pivoting structures, each of the planetary pivoting structures is constituted by a pin shaft integrated with transmission tray, and each pin shaft is slidingly fitted with each of the planetary gears.

In the graded transmission module, it may be constituted by stacking a plurality of the graded transmission modules successively, and the concave hole of the transmission tray is provided for positioning a head end of the power shaft of the power input module or positioning a shaft of a next stage transmission tray, and the shaft of the transmission tray may align with the planet wheel set hole of the power output module or a concave hole of a previous stage transmission tray, so as to align the axis center of each graded transmission module.

In the planetary gear, a chamfer is disposed at an end surface of the planetary gear facing the transmission tray, so as to reduce the area contacting with the end surface. Furthermore, a concentric flange is disposed on the periphery of each planetary pivoting structure, an abrasion-resistant spacer is disposed between each concentric flange and each planetary gear, and each concentric flange has a flange wall of the continuous type or the discontinuous type.

In the transmission tray, a concentric flange is disposed around the periphery of the concave hole of the transmission tray, an abrasion-resistant spacer is disposed between the concentric flange and the power shaft or between the concentric flange and a shaft of a previous stage transmission tray, and the concentric flange has a flange wall of the continuous type or the discontinuous type; moreover, the power shaft of the power input module is driven by a motor.

The present invention is characterized in a design of combining a sun gear with a planetary arm through a molding process, in which an axle center protruded from a top end may be concentrically assigned with a central concave hole of a next stage planetary arm. Concentric flanges are punched at positions of holes on the planetary arm through the molding process, which are used to reduce an area of the planetary arm rubbed by planetary gears in rotation. An outer diameter of the assembled planetary gears is also limited by an addendum circle of an internal gear. Therefore, not only the processing quality of the parts of the planetary gear assembly can be determined to exclude the defective parts after the planetary arm is assembled with the planetary gears, but also the gear assembly is prevented from generating interference, jam, and noises, thereby ensuring the concentric and stable operation of all parts of the planetary gear assembly.

### BRIEF DESCRIPTION OF THE DRAWINGS

FIG. 1 is a perspective sectional view of a planetary arm of a concentrically aligned planetary gear assembly according to an embodiment of the present invention;

FIG. 2 is a perspective sectional view of assembling basic parts of a concentrically aligned planetary gear assembly according to an embodiment of the present invention;

FIG. 3A is a perspective drawing of flanges with continuous-type flange walls in a concentrically aligned planetary gear assembly according to an embodiment of the present invention;

FIG. 3B is a perspective drawing of flanges with discontinuous-type flange walls in a concentrically aligned planetary gear assembly according to an embodiment of the present invention;

FIG. 4A is a perspective drawing of determining defective parts from basic parts of a concentrically aligned planetary gear assembly according to an embodiment of the present invention during assembly;

FIG. 4B is a side view of FIG. 4A;

FIG. 5A is a perspective drawing of determining qualified parts from basic parts of a concentrically aligned planetary gear assembly according to an embodiment of the present invention during assembly;

FIG. 5B is a side view of FIG. 5A;

FIG. 6A is a perspective sectional view of a power transmission device according to an embodiment of the present invention, in which an output shaft is in parallel with a motor output shaft;

FIG. 6B is a side view of FIG. 6A;

FIG. 7A is a perspective drawing of a power transmission device according to an embodiment of the present invention, in which a compound gear is used to increase a gear reduction ratio;

FIG. 7B is a side view of FIG. 7A;

FIG. 8A is a perspective drawing of a parallel stack embodiment of a power transmission device applying a single motor to drive two concentrically aligned planetary gear assemblies according to the present invention;

FIG. 8B is a side view of FIG. 8A;

FIG. 9A is a perspective drawing of a tapered stack embodiment of a power transmission device applying a single motor to drive two concentrically aligned planetary gear assemblies according to the present invention;

FIG. 9B is a side view of FIG. 9A;

FIG. 10A is a perspective drawing of a power transmission device applying a single motor to drive more than two concentrically aligned planetary gear assemblies according to an embodiment of the present invention;

FIG. 10B is a side view of FIG. 10A;

FIG. 11A is a perspective drawing of a power transmission device applying two motors to drive one concentrically aligned planetary gear assembly according to an embodiment of the present invention; and

FIG. 11B is a side view of FIG. 11A.

### DETAILED DESCRIPTION OF THE INVENTION

Preferred embodiments of the present invention are described in detail below with reference to the accompanying drawings.

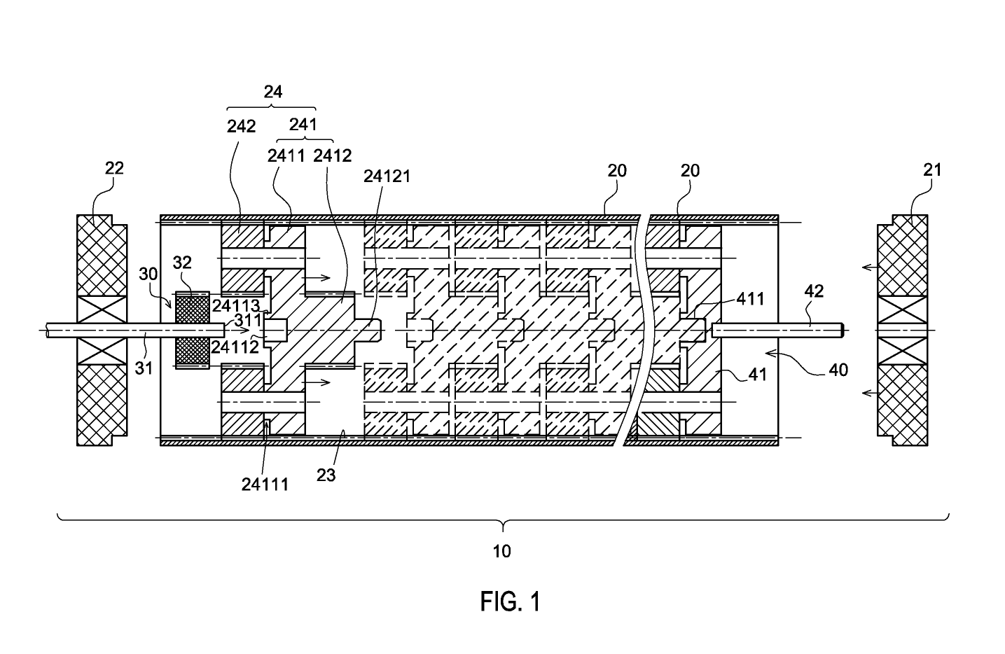

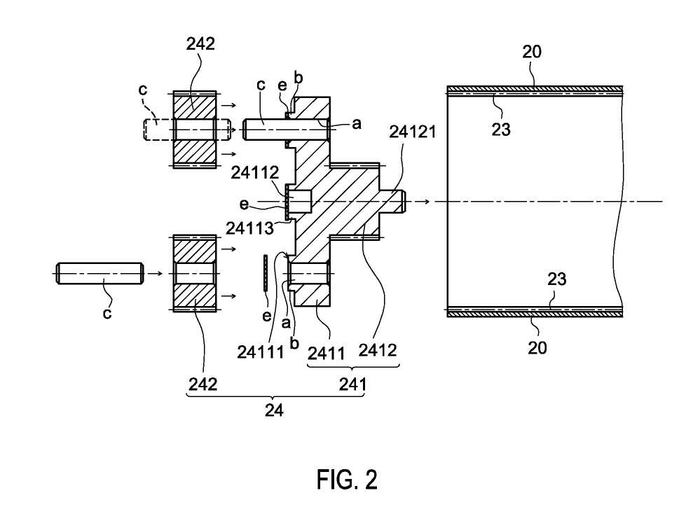

FIG. 1 is a perspective sectional view of a planetary arm of a concentrically aligned planetary gear assembly according to an embodiment of the present invention, and FIG. 2 is a perspective sectional view of assembling basic parts of a concentrically aligned planetary gear assembly according to an embodiment of the present invention. Referring to FIGS. 1 and 2, a concentrically aligned planetary gear assembly 10 includes: a ring gear 20, having a top cover 21 and a bottom cover 22 at two ends thereof, at least one graded transmission module 24, a power input module 30, and a power output module 40. An internal gear 23 is formed on an inner wall of the ring gear 20, and the at least one graded transmission module 24 is disposed at the section of the internal gear 23.

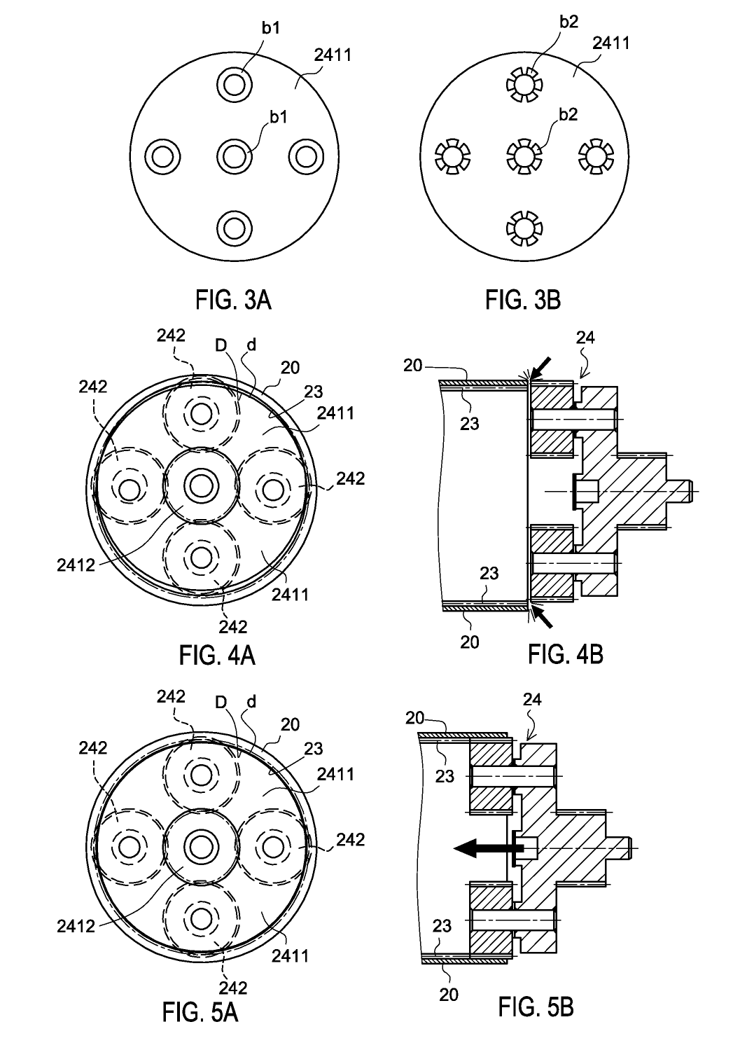

The graded transmission module 24 includes a planetary arm 241 having a transmission tray 2411 and a sun gear 2412, and the sun gear 2412 concentrically extends from a top surface of the transmission tray 2411. The transmission tray 2411 has a plurality of planetary pivoting structures 24111, and the planetary pivoting structures 24111 are distributed about an axle center of the transmission tray 2411 at equal radiuses and equal angles for assembling planetary gears 242. A central concave hole 24112 is formed at an axle center on a bottom surface of the transmission tray 2411 (a central flange 24113 may be disposed around the periphery of the central concave hole 24112, the flange walls of the central flange 24113 may be in a continuous type b1 or in a discontinuous type b2, for example, FIG. 3A is a perspective drawing of flanges with continuous-type flange walls in a concentrically aligned planetary gear assembly according to an embodiment of the present invention, and FIG. 3B is a perspective drawing of flanges with discontinuous-type flange walls in a concentrically aligned planetary gear assembly according to an embodiment of the present invention). A central shaft 24121 is provided at the axle center on a top surface of the sun gear 2412, and after the assembling process, the axle center of the transmission tray 2411 substantially coincides with the axle center of the internal gear 23, and a gap exists between the transmission tray 2411 and the internal gear 23 (that is, a diameter D of an addendum circle of the internal gear is larger than a diameter d of an outer edge of the transmission tray). A plurality of planetary gears 242 is pivoted to the planetary pivoting structures 24111 on the bottom surface of the transmission tray 2411 and freely rotates with respect to the planetary pivoting structures 24111. Each planetary gear 242 is engaged with the internal gear 23 and the sun gear 2412 of another graded transmission module 24 during assembly. In the drawings, the transmission tray 2411 is configured into a disk shape, but the present invention is not limited thereto, and the transmission tray 2411 may be of other shapes in consideration of reducing the weight or other reasons.

In addition, a chamfer is disposed at an end surface of each planetary gear 242 facing the transmission tray 2411, so as to reduce the area contacting with the end surface. Furthermore, a flange b, having a flange wall of the continuous type b1 or the discontinuous type b2, is disposed around the periphery of a shaft hole a at the position of each planetary pivoting structure 24111, so as to reduce the frictional force and noises generated between the planetary gears 242 and the transmission tray 2411. An abrasion-resistant spacer e is disposed between each flange b and each planetary gear 242 and/or between the central flange 24113 and the power input gear 32 of the power input module 30 or between the central flange 24113 and the sun gear 2412 of a previous graded transmission module, so as to enhance the abrasion resistance.

The power input module 30 is disposed at an inner side of the bottom cover 22, and has a power shaft 31 and a power input gear 32 secured on the power shaft 31. The power input gear 32 is engaged with each planetary gear 242 of the adjacent graded transmission module 24, so as to input power to the graded transmission module 24.

The power output module 40 is disposed at an inner side of the top cover 21, and has a planet wheel set 41 and a secured output shaft 42. The planet wheel set 41 has a plurality of planetary pivoting structures for assembling the planetary gears 242, and is engaged with the sun gear 2412 of the adjacent graded transmission module 24 to output the power. The axle center of the planet wheel set 41 has a hole 411 for being aligned and assembled with the central shaft 24121 of the graded transmission module 24.

FIG. 4A is a perspective drawing of determining defective parts from basic parts of a concentrically aligned planetary gear assembly according to an embodiment of the present invention during assembly, FIG. 4B is a side view of FIG. 4A, FIG. 5A is a perspective drawing of determining qualified parts from basic parts of a concentrically aligned planetary gear assembly according to an embodiment of the present invention during assembly, and FIG. 5B is a side view of FIG. 5A. Referring to FIGS. 4A, 4B, 5A and 5B, the central concave hole 24112 on the transmission tray 2411 of the graded transmission module 24 in this embodiment is provided for being aligned with the central shaft 24121 of a next stage transmission tray 2411. Moreover, the concentricity of the sun gear 2412, the central concave hole 24112, the central flange 24113, the central shaft 24121, and the outer edge of the transmission tray 2411, and the concentricity of the shaft hole a and the flange b can be improved through a molding process (as shown in FIGS. 5A and 5B). After improving the concentricity of the above members, the parts having defective sizes can be found and excluded. For example, if the outer edge d of the transmission tray 2411 is eccentric with the central shaft 24121 (having a poor concentricity), when the transmission tray 2411 is assembled to the internal gear 23 of the ring gear 20, the central shaft 24121 cannot be aligned correctly (with the central concave hole 24112 of another transmission tray 2411) to cause interference, and thus the assembling process is unable to be achieved successfully (as shown in FIGS. 4A and 4B). Alternatively, the precisely positioned shaft hole a on the transmission tray 2411 can examine the concentricity of the shaft hole of each planetary gear 242 assembled on the transmission tray 2411 and a pitch circle thereof.

In the above embodiments, the planetary pivoting structures 24111 merely serve as a structure for assembling the transmission tray 2411 with the planetary gears 242, and the specific implementation thereof is not limited in the present invention. For example, a shaft hole a is disposed on the transmission tray 2411 and a pin shaft c fixed in the shaft hole a (definitely, the pin shaft c may also be directly molded on the transmission tray 2411), and each pin shaft c is slidingly fitted with each planetary gear 242, such that the planetary gear 242 rotates freely.

It should be noted that, a plurality of the graded transmission modules 24 may be stacked successively, and the central concave hole 24112 of the transmission tray 2411 is provided for positioning a head end 311 of the power shaft 31 of the power input module 30 or positioning a central shaft of a next stage transmission tray, and the central shaft 24121 of the transmission tray 2411 may be aligned with the planet wheel set hole 411 of the power output module 40 or a central concave hole of a previous stage transmission tray, thereby improving the concentricity of the combined graded transmission modules 24.

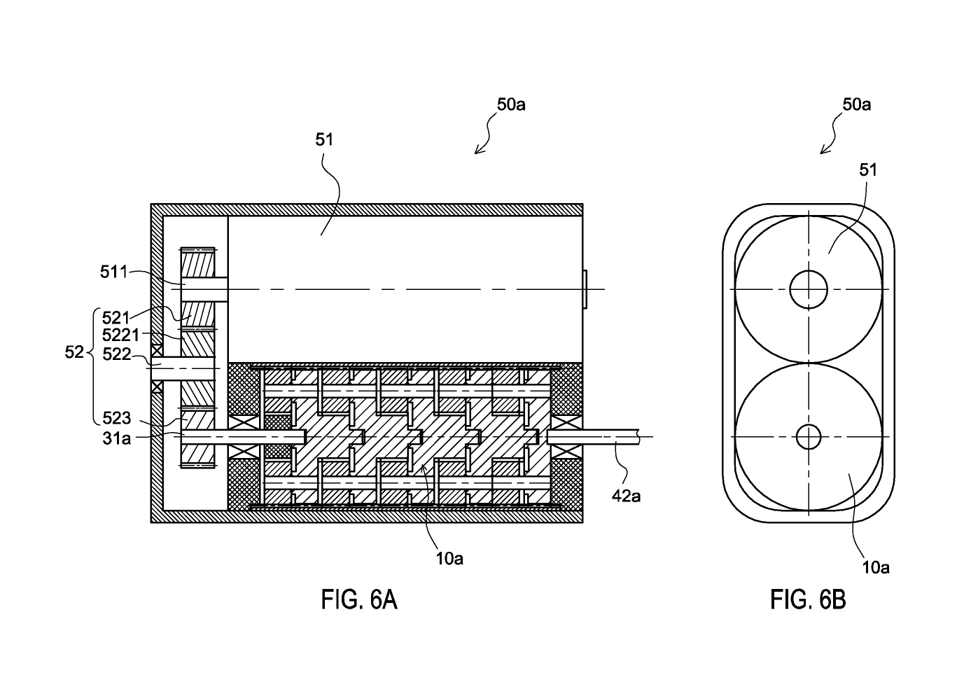

FIG. 6A is a perspective sectional view of a power transmission device according to an embodiment of the present invention, in which an output shaft is in parallel with a motor output shaft, and FIG. 6B is a side view of FIG. 6A. Referring to FIGS. 6A and 6B, a power transmission device 50a applying the above embodiments of the concentrically aligned planetary gear assembly includes a first motor 51, a first medium gear set 52, and a first concentrically aligned planetary gear assembly 10a. The first motor 51 has a motor output shaft 511 and serves as a power source of the power transmission device 50a.

The first medium gear set 52 has a first input gear 521 connected to the motor output shaft 511, for driving a first medium gear 5221 assembled on a first medium gear shaft 522, and the first medium gear 5221 is engaged with a first output gear 523.

The first concentrically aligned planetary gear assembly 10a includes members of the above embodiments of the concentrically aligned planetary gear assembly 10, such as the ring gear 20, the power input module 30, and the power output module 40, in which a power shaft 31a of the power input module 30 is joined to the first output gear 523, for providing power to the first output gear 523. Through the motor output shaft 511 of the first motor 51 in the above embodiment, the first medium gear set 52 drives the first concentrically aligned planetary gear assembly 10a to rotate axially in parallel, and an output shaft 42a outputs the power in a reduced rate.

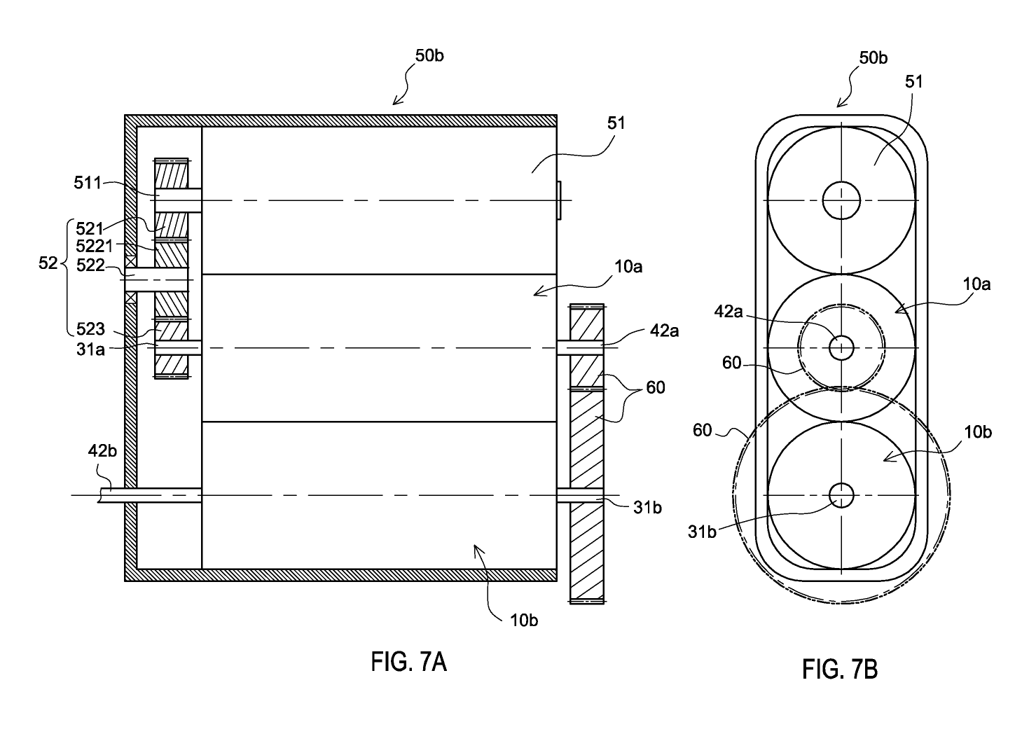

FIG. 7A is a perspective drawing of a power transmission device according to an embodiment of the present invention, in which a compound gear is used to increase a gear reduction ratio, and FIG. 7B is a side view of FIG. 7A. Referring to FIGS. 7A and 7B, a power transmission device 50b in this embodiment is an application of the power transmission device 50a in the above embodiment. The first motor 51 transmits power to the power shaft 31 a of the first concentrically aligned planetary gear assembly 10a through the first medium gear set 52. A cascaded gear set 60 is disposed on the output shaft 42a of the first concentrically aligned planetary gear assembly 10a and connected to a power shaft 31b of a second concentrically aligned planetary gear assembly 10b, and an output shaft 42b outputs the power in a reduced rate. The first motor 51, the first concentrically aligned planetary gear assembly 10a, and the second concentrically aligned planetary gear assembly 10b are stacked longitudinally and are arranged in parallel with each other.

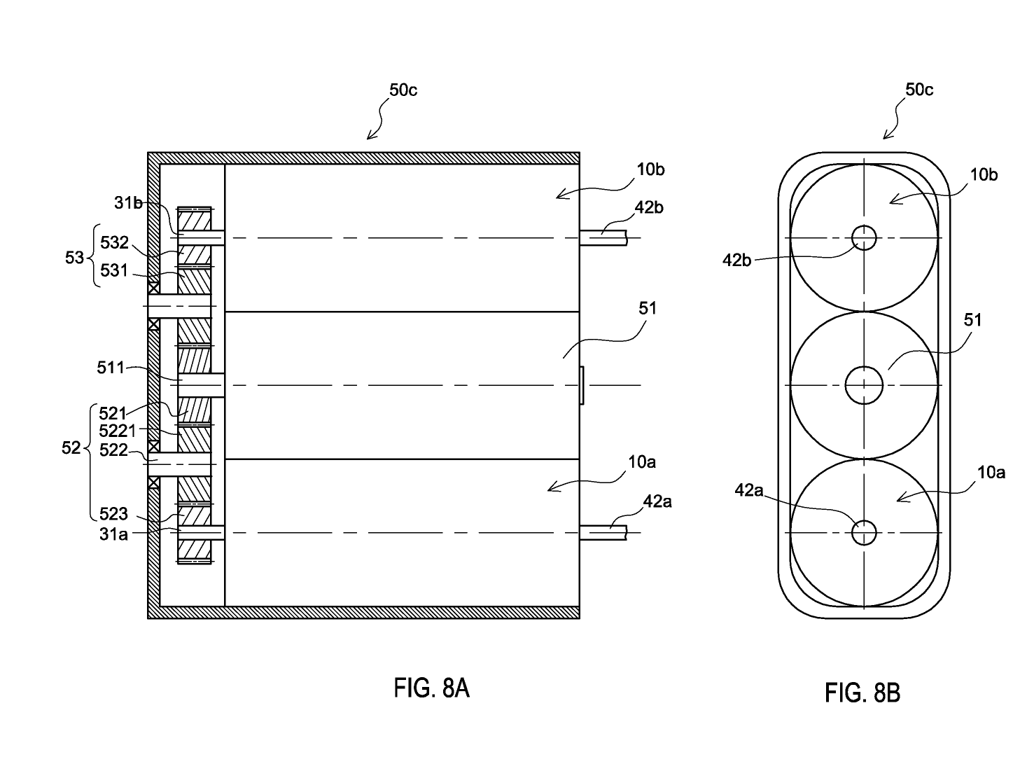

FIG. 8A is a perspective drawing of a parallel stack embodiment of a power transmission device applying a single motor to drive two concentrically aligned planetary gear assemblies according to the present invention, and FIG. 8B is a side view of FIG. 8A. Referring to FIGS. 8A and 8B, a power transmission device 50c is an extended application of the power transmission device 50a. The first motor 51 transmits power to the power shaft 31a of the first concentrically aligned planetary gear assembly 10a through the first medium gear set 52. A second concentrically aligned planetary gear assembly 10b is additionally disposed at the other parallel side of the first motor 51 of the power transmission device 50a. By using a second medium gear 531 and a second input gear 532 engaged with each other in the second medium gear set 53 corresponding to each member of the first medium gear set 52, the motor output shaft 511 of the first motor 51 is connected to the power shaft 31b of the second concentrically aligned planetary gear assembly 10b, such that the first motor 51 simultaneously drives the first concentrically aligned planetary gear assembly 10a and the second concentrically aligned planetary gear assembly 10b by using the first medium gear set 52 and the second medium gear set 53, and the output shafts (42a, 42b) output the power in a reduced rate.

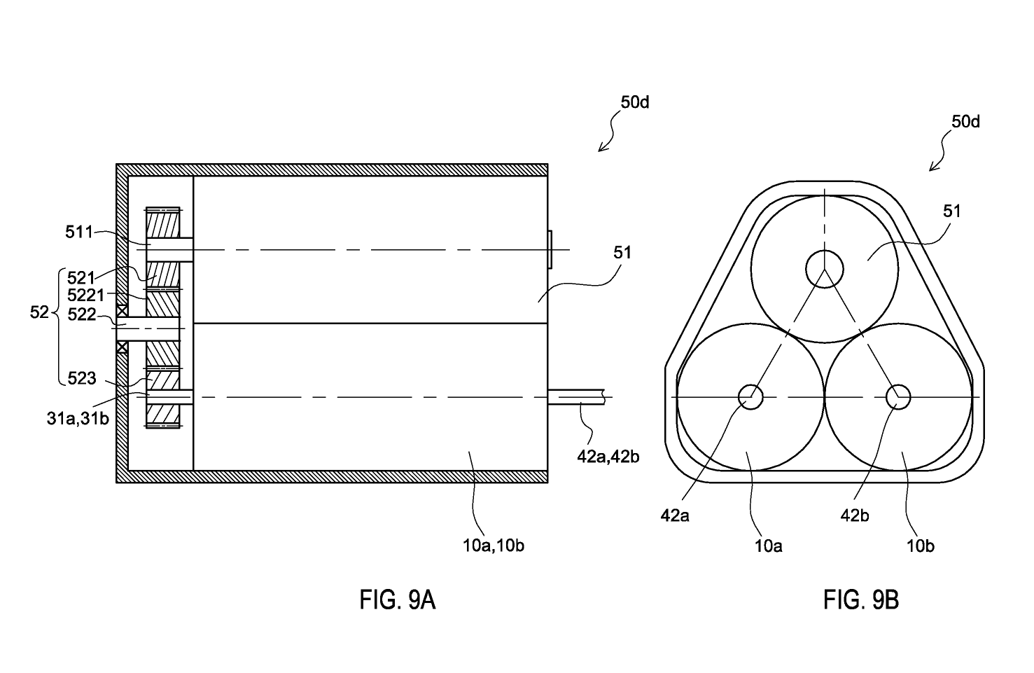

FIG. 9A is a perspective drawing of a tapered stack embodiment of a power transmission device applying a single motor to drive two concentrically aligned planetary gear assemblies according to the present invention, and FIG. 9B is a side view of FIG. 9A. Referring to FIGS. 9A and 9B, a power transmission device 50d of this embodiment is still an extended application of the power transmission device 50a. In the power transmission device 50d, the first motor 51 transmits power to the power shaft 31a of the first concentrically aligned planetary gear assembly 10a through the first medium gear set 52. A second concentrically aligned planetary gear assembly 10b is further disposed, and thus the first motor 51, the first concentrically aligned planetary gear assembly 10a, and the second concentrically aligned planetary gear assembly 10b are arranged in parallel with each other and configured in a tapered stack manner. The first medium gear set 52 is not only engaged with the power shaft 31a of the first concentrically aligned planetary gear assembly 10a, but also engaged with the power shaft 31b of the second concentrically aligned planetary gear assembly 10b, and the output shafts (42a, 42b) output the power in a reduced rate.

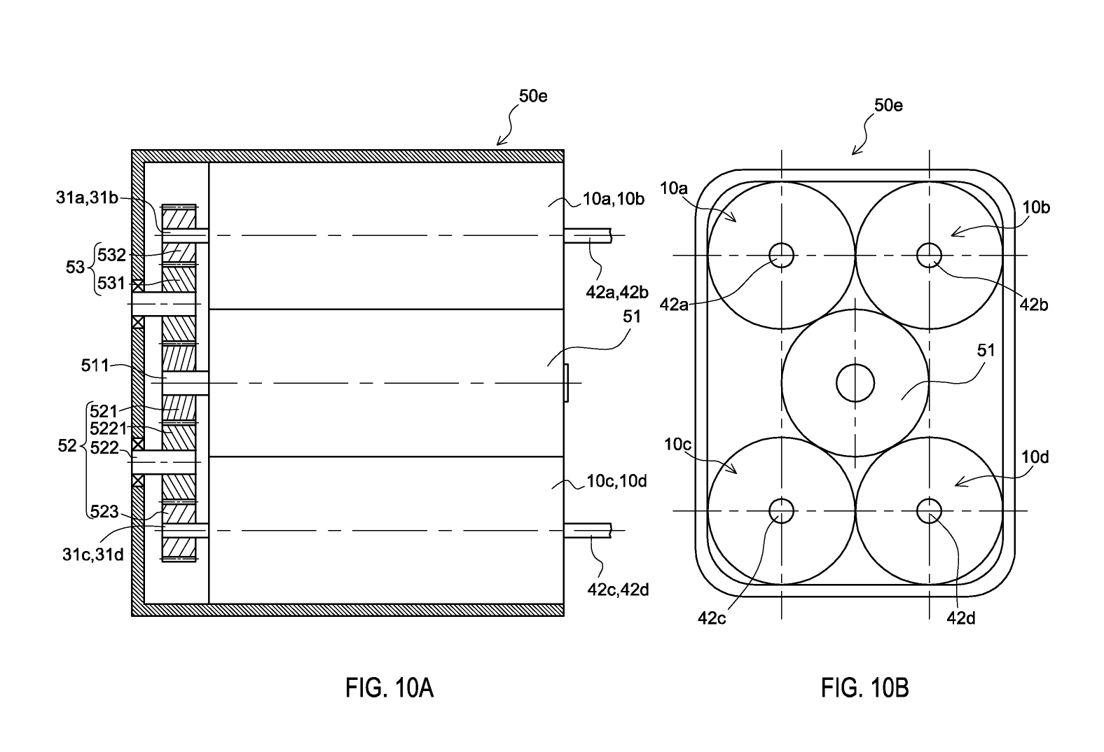

FIG. 10A is a perspective drawing of a power transmission device applying a single motor to drive more than two concentrically aligned planetary gear assemblies according to an embodiment of the present invention, and FIG. 10B is a side view of FIG. 10A. Referring to FIGS. 10A and 10B, a power transmission device 50e of this embodiment is an extended application of combining the power transmission device 50c with the power transmission device 50d, which is a mirror variation of the tapered stack configuration of the power transmission device 50d that is arranged in parallel. The first motor 51 transmits power to the power shaft 31a of the first concentrically aligned planetary gear assembly 10a and the power shaft 31b of the second concentrically aligned planetary gear assembly 10b through the first medium gear set 52 at one side thereof, and the other mirror part of the first motor 51 transmits power to a power shaft 31c of a third concentrically aligned planetary gear assembly 10c and a power shaft 31d of a fourth concentrically aligned planetary gear assembly 10d by taking the second medium gear set 53 as the connection, so as to simultaneously transmit the power of the first motor 51 to the first concentrically aligned planetary gear assembly 10a, the second concentrically aligned planetary gear assembly 10b, the third concentrically aligned planetary gear assembly 10c, and the fourth concentrically aligned planetary gear assembly 10d, and the output shafts (42a, 42b, 42c, 42d) thereof output the power in a reduced rate.

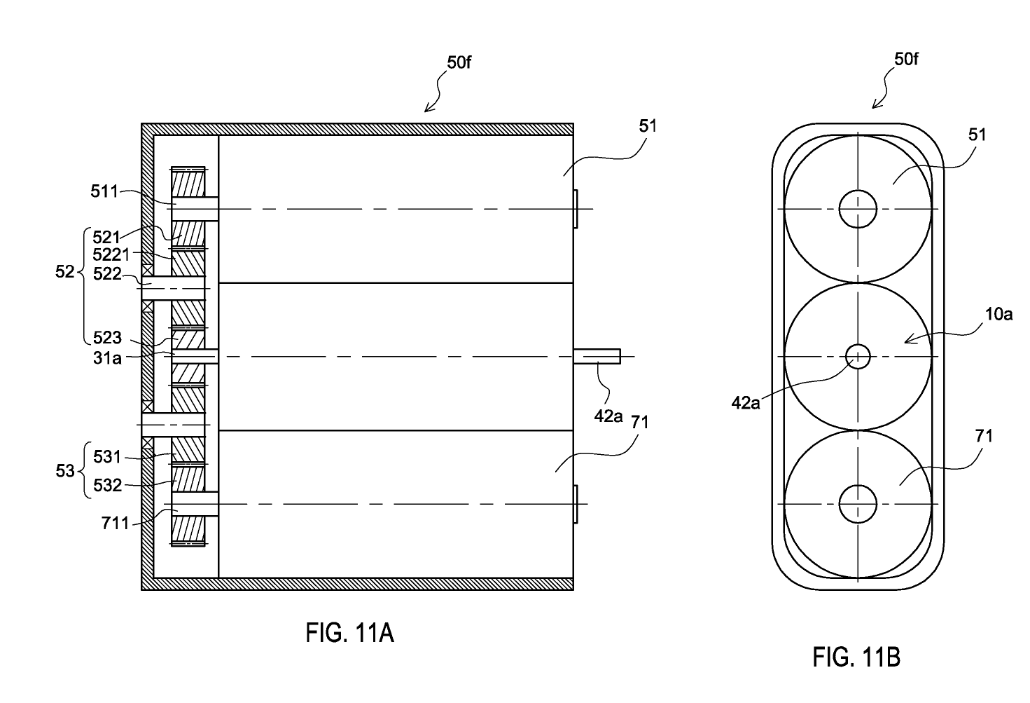

FIG. 11A is a perspective drawing of a power transmission device applying two motors to drive one concentrically aligned planetary gear assembly according to an embodiment of the present invention, and FIG. 11B is a side view of FIG. 11A. Referring to FIGS. 11A and 11B, a power transmission device 50f of this embodiment is an extended application of the power transmission device 50a. The first motor 51 transmits power to the power shaft 31 a of the first concentrically aligned planetary gear assembly 10a through the first medium gear set 52. A second motor 71 and a second motor output shaft 711 connected to the second motor 71 are disposed in parallel at the other side of the first concentrically aligned planetary gear assembly 10a opposite to the first motor 51. By using the second medium gear 531 and the second input gear 532 of the second medium gear set 53, the second motor 71 is connected to the first output gear 523 that is connected to the power shaft 31a of the first concentrically aligned planetary gear assembly 10a, so that the first motor 51 and the second motor 71 simultaneously drive the first concentrically aligned planetary gear assembly 10a, and the output shaft 42a thereof outputs the power in a reduced rate.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A concentrically aligned planetary gear assembly, comprising:
a ring gear, having a bottom cover and a top cover disposed at two ends thereof, wherein an internal gear is formed on an inner wall of the ring gear;
at least one graded transmission module, disposed inside the ring gear, and comprising:
a planetary arm, having a transmission tray and a sun gear, wherein the sun gear concentrically extends from a top surface of the transmission tray, the transmission tray has a plurality of planetary pivoting structures distributed about an axle center thereof at equal radiuses and equal angles, a central concave hole is formed at an axle center on a bottom surface of the transmission tray, and a central shaft is disposed at an axle center on a top surface of the sun gear, and after assembling, the axle center of the transmission tray coincides with that of the internal gear, and a gap exists between the transmission tray and the internal gear; and
a plurality of planetary gears, pivoted to the planetary pivoting structures on bottom surface of the transmission tray, wherein each of the planetary gears is engaged with the internal gear;
a power input module, disposed at an inner side of the bottom cover, and having a power shaft and a power input gear secured at one end of the power shaft, wherein the power input gear is engaged with each of the planetary gears of the adjacent graded transmission module, for inputting power to the graded transmission module; and
a power output module, disposed at an inner side of the top cover, and having a planet wheel set and a secured output shaft, for outputting power of the sun gear of the adjacent graded transmission module, wherein a hole is formed at a axle center on a bottom surface of the planet wheel set.

2. The concentrically aligned planetary gear assembly according to claim 1, wherein each of the planetary pivoting structures comprises a shaft hole on the transmission tray and a pin shaft fixed in the shaft hole, and each pin shaft is slidingly fitted with each of the planetary gears.

3. The concentrically aligned planetary gear assembly according to claim 2, wherein a flange is disposed at a periphery of the shaft hole at position of each of the planetary pivoting structures of the transmission tray.

4. The concentrically aligned planetary gear assembly according to claim 3, wherein an abrasion-resistant spacer is disposed between each flange and each planetary gear.

5. The concentrically aligned planetary gear assembly according to claim 3, wherein the flange has a continuous-type flange wall or a discontinuous-type flange wall.

6. The concentrically aligned planetary gear assembly according to claim 1, wherein a central flange is disposed at a periphery of the central concave hole on the bottom surface of the transmission tray.

7. The concentrically aligned planetary gear assembly according to claim 6, wherein an abrasion-resistant spacer is disposed between the central flange and the power input gear of the power input module or between the central flange and a sun gear of a previous graded transmission module.

8. The concentrically aligned planetary gear assembly according to claim 6, wherein the central flange has a continuous-type flange wall or a discontinuous-type flange wall.

9. The concentrically aligned planetary gear assembly according to claim 1, wherein the power shaft of the power input module is driven by a motor.

10. A power transmission device, comprising:
a first motor, having a motor output shaft;
a first medium gear set, having a first input gear connected to the motor output shaft, so as to drive a first medium gear assembled to a first medium gear shaft, wherein the first medium gear is engaged with a first output gear; and
a first concentrically aligned planetary gear assembly, comprising:
a ring gear, having a bottom cover and a top cover disposed at two ends thereof, wherein an internal gear is formed on an inner wall of the ring gear;
at least one graded transmission module, disposed inside the ring gear, and comprising:
a planetary arm, having a transmission tray and a sun gear, wherein the sun gear concentrically extends from a top surface of the transmission tray, the transmission tray has a plurality of planetary pivoting structures distributed about an axle center thereof at equal radiuses and equal angles, a central concave hole is formed at an axle center on a bottom surface of the transmission tray, and a central shaft is disposed at an axle center on a top surface of the sun gear, and after assembling, the axle center of the transmission tray coincides with that of the internal gear, and a gap exists between the transmission tray and the internal gear; and
a plurality of planetary gears, pivoted to the planetary pivoting structures on the bottom surface of the transmission tray, wherein each of the planetary gears is engaged with the internal gear;
a power input module, disposed inside the bottom cover, and having a power shaft assembled with the first output gear and a power input gear secured at the power shaft, wherein the power input gear is engaged with each of the planetary gears of the adjacent graded transmission module; and
a power output module, disposed inside the top cover, and having a planet wheel set and a secured output shaft, for outputting power of the sun gear of the adjacent graded transmission module, wherein a hole is formed at an axle center on a bottom surface of the planet wheel set.

11. The power transmission device according to claim 10, wherein a flange is disposed at a periphery of a shaft hole at position of each of the planetary pivoting structures of the transmission tray.

12. The power transmission device according to claim 11, wherein an abrasion-resistant spacer is disposed between each flange and each planetary gear.

13. The power transmission device according to claim 11, wherein the flange has a continuous-type flange wall or a discontinuous-type flange wall.

14. The power transmission device according to claim 10, wherein a central flange is disposed at a periphery of the central concave hole on the bottom surface of the transmission tray.

15. The power transmission device according to claim 14, wherein an abrasion-resistant spacer is disposed between the central flange and the power input gear of the power input module or between the central flange and a sun gear of a previous graded transmission module.

16. The power transmission device according to claim 14, wherein the central flange has a continuous-type flange wall or a discontinuous-type flange wall.

17. The power transmission device according to claim 10, wherein the first motor and the first concentrically aligned planetary gear assembly are stacked longitudinally.

18. The power transmission device according to claim 10, further comprising: a second concentrically aligned planetary gear assembly longitudinally stacked under the first concentrically aligned planetary gear assembly, wherein the output shaft of the first concentrically aligned planetary gear assembly and a power shaft of the second concentrically aligned planetary gear assembly are disposed at same side, a cascaded gear set is used to reduce an output power of the first concentrically aligned planetary gear assembly and transmit the reduced output power to the second concentrically aligned planetary gear assembly, and an output shaft of the second concentrically aligned planetary gear assembly outputs the power.

19. The power transmission device according to claim 10, further comprising a second medium gear set and a second concentrically aligned planetary gear assembly, wherein the second medium gear set further comprises a second medium gear and a second output gear engaged with the second medium gear, the second medium gear is engaged with the first input gear, the second output gear is disposed on a power shaft of the second concentrically aligned planetary gear assembly to drive the second concentrically aligned planetary gear assembly, and a structure of the second concentrically aligned planetary gear assembly is equivalent to a structure of the first concentrically aligned planetary gear assembly.

20. The power transmission device according to claim 19, wherein the first motor and the first and the second concentrically aligned planetary gear assemblies are stacked longitudinally.

21. The power transmission device according to claim 19, wherein the first concentrically aligned planetary gear assembly and the second concentrically aligned planetary gear assembly are arranged horizontally in parallel, and the first motor is stacked above the first concentrically aligned planetary gear assembly and the second concentrically aligned planetary gear assembly.

22. The power transmission device according to claim 21, further comprising: a third concentrically aligned planetary gear assembly and a fourth concentrically aligned planetary gear assembly, arranged horizontally in parallel, and stacked above the first motor.

23. The power transmission device according to claim 10, further comprising: a second motor and a second medium gear assembly, wherein the second motor has a second motor output shaft, and the second medium gear assembly further comprises a second medium gear and a second input gear engaged with the second medium gear, the second medium gear is engaged with the first output gear, and the second input gear is connected to the second motor output shaft.

24. The power transmission device according to claim 23, wherein the first motor, the second motor, and the first concentrically aligned planetary gear assembly are stacked longitudinally.

25. The power transmission device according to claim 23, wherein the first motor and the second motor are arranged horizontally in parallel, and the first concentrically aligned planetary gear assembly is stacked above the first motor and the second motor.
